(19) United States
(12) Patent Application Publication
(10) Pub. No.: US 2026/0086654 A1
(43) Pub. Date: Mar. 26, 2026

(54) INPUT DEVICE AND SEARCH METHOD PERFORMED THROUGH THE INPUT DEVICE

(71) Applicant: DEXIN CORPORATION, New Taipei City (TW)

(72) Inventor: HO-LUNG LU, NEW TAIPEI CITY (TW)

(21) Appl. No.: 19/021,191

(22) Filed: Jan. 15, 2025

(30) Foreign Application Priority Data
Sep. 20, 2024 (TW) 113135632

(51) Int. Cl. G06F 3/02

(52) U.S. Cl. CPC G06F 3/0202

(57) ABSTRACT

An input device and a search method performed through the input device are provided. The method is performed in a computer system connected with the input device. The input device is used to select a search target. A search description is generated by the computer system. An identifier corresponding to a search engine can be retrieved from a memory of the input device. After that, the search target, the search description and the identifier are packaged into a search package. The search package is transmitted to the search engine via a network. The search engine relies on the search target and the search description retrieved from the search package to conduct search so as to generate a search result.

### CROSS-REFERENCE TO RELATED PATENT APPLICATION

This application claims the benefit of priority to Taiwan Patent Application No. 113135632, filed on Sep. 20, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a method of quick search, and more particularly to a search method performed through an input device that is used to trigger a search function and automatically connect with a search platform.

### BACKGROUND OF THE DISCLOSURE

Various information in various fields can be obtained by a variety of ways including traditional ways such as books, newspapers, magazines, radio and television programs, and modern ways such as computer devices that can be used to obtain abundant and diverse contents via network. For example, the user can acquire information quickly and conveniently by searching various articles and news on the network through search engines such as Google™, Microsoft Bing™ and Yahoo™.

Input interfaces provided by the search engines are main conventional ways to search for information on the network by inputting keywords or adding operators. The search engines can obtain the contents that match the keywords from various sources. Text search is currently the most common search way that can obtain a search result including texts, images and videos. Further, there is also a search method using an image to find images.

### SUMMARY OF THE DISCLOSURE

Rather than the conventional search methods, the present disclosure provides an input device and a search method performed through the input device. The method is performed in a computer system connected with the input device. The input device is used to submit a search target and an identifier corresponding to a search engine to the computer system, by which a quick and convenient search technology is achieved.

In one aspect, the input device connected with the computer system includes a controller, a memory and a transmission circuit. The memory records one or more identifiers corresponding to one or more search engines. A search hotkey or a combination of multiple keys of the input device can be used to trigger execution of the search method performed through the input device.

In the search method performed through the input device, a computer system relies on the search target obtained from the input device to generate a search description. The search description is combined with an identifier corresponding to a search engine from a memory of the input device. The search target, the search description and the identifier are packaged in a search package. The search package is transmitted to the search engine via network and the search engine performs searching according to the search target and the search description in the search package and obtains a search result.

The search target is a paragraph of text or a picture selected by the input device, and the search description can be a prompt text generated by a search program executed in the computer system for a natural language model.

In the computer system, a token of the natural language model can be used to transform the prompt text to the information processed by the natural language model.

Further, the identifier recorded in the memory of the input device is an API key that records a linking data of the search engine. The linking data is such as a URL of a search website operating the search engine.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram illustrating a computer system operating a search method performed through an input device according to one embodiment of the present disclosure;

FIG. 2 is a schematic diagram illustrating circuit components of a computer system performing the search method performed through the input device according to one embodiment of the present disclosure;

FIG. 3A is a schematic diagram illustrating operating the input device to circle a search target according to one embodiment of the present disclosure;

FIG. 3B is a schematic diagram illustrating using the input device to perform searching in one embodiment of the present disclosure; and

FIG. 4 is a flowchart illustrating the search method performed through the input device according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on. ” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure relates to an input device and a search method performed through the input device. One main implementation to activate a computer system to perform searching is based on a user who manipulates the input device such as a computer mouse, a keyboard, a stylus or a touch pad to select a search range, add an identifier stored in a memory of the input device, and provide a default search description or a search description generated by the computer system.

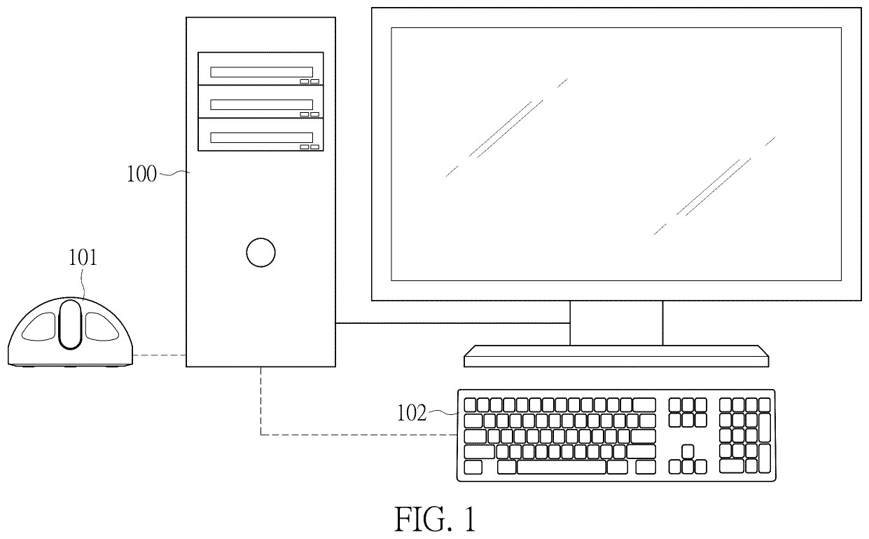

Reference is made to FIG. 1, which is a schematic diagram of a framework of a computer system performing the search method through the input device according to one embodiment of the present disclosure.

The computer system provides a computer host 100 and various input devices connected with the computer host 100. The input device can be a first input device 101 that is exemplified as a computer mouse or a second input device 102 that is exemplified as a computer keyboard.

In certain embodiments of the search method performed through the input device, in the beginning, the user manipulates the input device to select a search target that is combined with an identifier stored in a memory (e.g., a flash memory or an EEPROM) of the input device and a search description generated by an application of the computer host 100 that is operated by the user. The search target and the search description are transmitted to a search engine that corresponds to the identifier, and the search engine performs searching according to the search target and the search description, and generates a search result.

In one of the embodiments of the present disclosure, the memory of the input device can store one or more identifiers. The identifier can be an application program interface key (API Key) that is used to link to services provided by a specific search engine. The API Key can be used to record a URL of a search website of a search engine. According to one embodiment, the API Key can be a unique code that is composed of a series of characters and/or symbols, and is used to identify and verify a specific application. The API Key can be provided by a specific service provider (e.g., a manufacturer of the input device), and can be used to as a token.

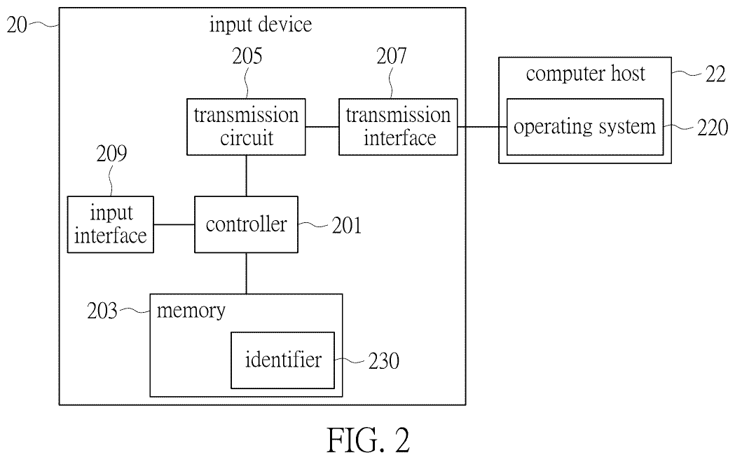

Reference is made to FIG. 2, which is a schematic diagram illustrating circuit components of a computer system performing the search method performed through the input device according to one embodiment of the present disclosure.

The diagram shows a circuit block diagram of an input device 20 connected with a computer host 22. The input device 20 includes a controller 201 and circuit components of a controller 201. The circuit components include a memory 203 can be any type of storage element in an electronic device. Besides the system data operating the input device 20, the memory 203 also stores one or more identifiers corresponding to one or more search engines. The circuit components of the input device 20 include a transmission circuit 205 that is electrically connected with the controller 201 and connects with the computer system via a transmission interface 207. For example, the computer system includes a computer host 22 and an operating system 220 that is operated through collaboration of hardware and software.

It should be noted that the scope of the embodiments of the present disclosure is not limited to following examples. The input device 20 can be connected with the computer host 22 in a wired or wireless manner. With a computer mouse as an example, an input interface 209 of the input device 20 is left and right keys, a rolling wheel or a touch interface of the computer mouse. With a computer keyboard as an example, the input interface 209 of the input device 20 can be a keypad, or any accompanied input functions. With a touch pad as an example, the input interface 209 of the input device 20 can be a touch panel and any pressable design thereon.

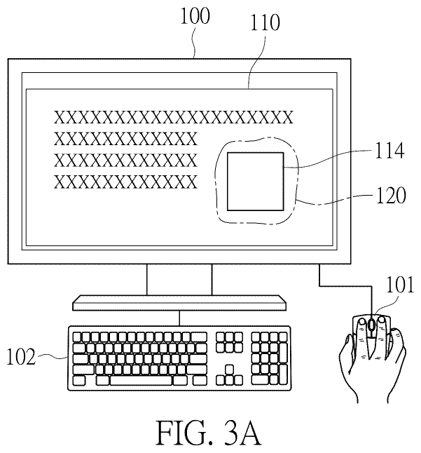

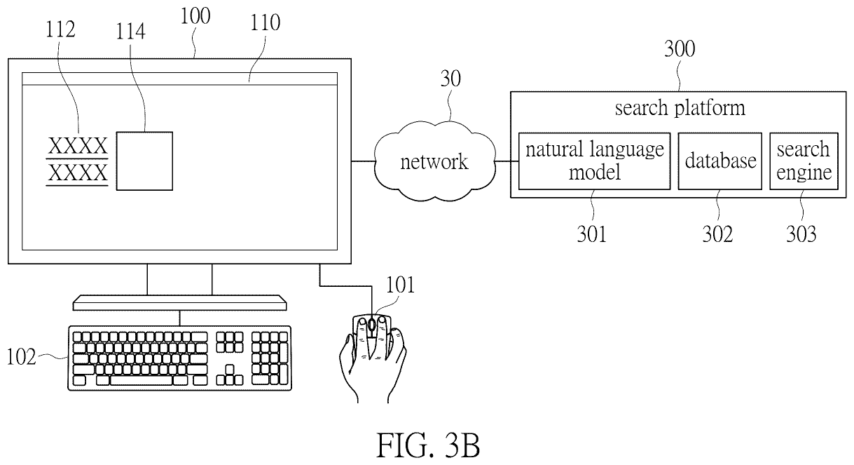

The computer system means the computer host and the operating system operated therein. FIG. 3A and FIG. 3B are referred to as the schematic diagrams illustrating the relevant implementation circumstance when performing the search method performed through the input device according to the certain embodiments of the present disclosure.

As FIG. 3A shows, when the computer system is in operation, connections between a computer host 100 and both a first input device 101 and a second input device 102 are established. The computer host 100 operates an operating system and applications. A user interface 110 is firstly initiated and, in the meantime, a user uses an application to browse documents or websites. The user can use the first input device 101 or the second input device 102 to select a search target 114 on the user interface 110 by a selection tool, and then input a search description for assisting searching on the user interface 110.

For example, the first input device 101 (e.g., a computer mouse) shown in the diagram is disposed with a search hotkey. The search hotkey or a combination of the search hotkey with any of current keys can be used to trigger execution of a quick-search function when the user clicks on the search hotkey or combined with the other key. In the meantime, the user manipulates the first input device 101 to circle a search range 120 that may cover a paragraph of text or a picture. The content within the search range 120 forms the search target 114. The circled content can be buffered to a memory of the first input device 101. When the search function is in operation, the first input device 101 transmits an identifier (e.g., an identifier 230 in a memory 203 of FIG. 2) in the memory and the search target 114 to the operating system operated in the computer host 100.

Next, the operating system receives the search description inputted by the user who manipulates the second input device 102 via the user interface 110, or adopts a pre-determined default search description. After that, the search target 114, the identifier and the search description are packaged in a search package. The search package is then transmitted to a search engine corresponding to the identifier, and the search engine performs searching according to the search target and the search description in the search package. A search result is then generated and transmitted back to the computer host 100.

According to one of the embodiments of the present disclosure, the identifier is such as an API key. In addition to recording a linking data of a search engine (e.g., a specific natural language model implemented search service), the identifier can be used as a basis for authenticating and authorizing the input device to use the search service, for example, a search service using a large language model such as ChatGPT. In the meantime, a search description such as a prompt text for a large language model, a search target, and the API key are packaged to form a search package. The search package is then transmitted to a search platform that can be implemented by the large language model.

Next, reference is made to FIG. 3B, which is a schematic diagram illustrating using the input device to perform searching in one embodiment of the present disclosure.

The computer host 100 connects with a search platform 300 via a network 30. The search platform 300 provides a cloud search service that is implemented by a computer system. The search platform 300 can be a service provider of a large language model search service. In one embodiment of the present disclosure, the search platform 300 includes a natural language model 301 that is configured to provide a database 302 with search contents and a search engine 303 that is implemented by the natural language model 301 which is collaborated with hardware.

When the search method is performed, an operating system operated in the computer host 100 initiates the user interface 110 for displaying an inputted or default search description 112 and the search target 114 to be searched. The search package packaging the search target 114, the identifier and the search description 112 is transmitted to the search platform 300 corresponding to the identifier.

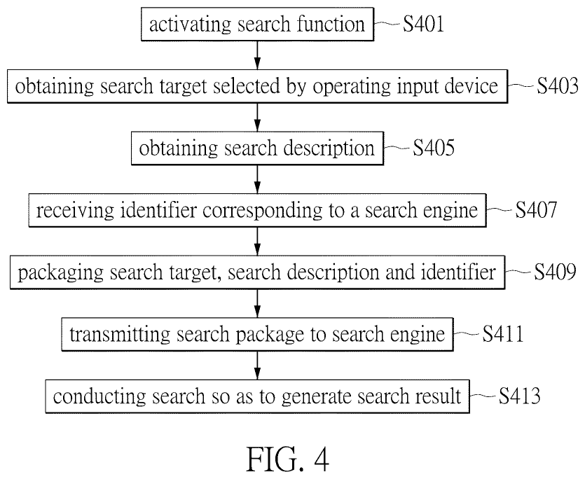

FIG. 4 shows a flowchart illustrating the search method performed in a computer system according to one embodiment of the present disclosure.

The user operates the input device and uses a search hotkey or a combination of multiple keys of the input device to trigger a searching function (step S401). The computer system receives the search target being selected by operating the input device (step S403). The search target can be a paragraph of text, a picture selected by the input device or the like. Next, the computer system receives the search description (step S405). The search description can be a prompt text applied to a specific natural language model generated by a search program executed in the computer system.

The computer system retrieves an identifier corresponding to a search engine from the input device (step S407), and packages the search target, the search description and the identifier in a search package, in which some security measures such as encryption and encoding can be properly incorporated (step S409). The search package is then transmitted to the search engine corresponding to the identifier (step S411). The search engine performs searching according to the search target and the search description extracted from the search package so as to obtain a search result (step S413). A purpose of quick searching triggered by the input device is accordingly achieved.

It is worth noting that the search platform implements a search engine by the natural language model. A search program executed in the computer system uses a token of the natural language model to transform the search description (i.e., the prompt text) to information that can be processed by the natural language model. Therefore, complexity of computation of the search platform implemented by the large language model can be reduced, and searching cost can also be declined. For example, in response to the token of the natural language model, the search program can tokenize a whole paragraph of content into multiple small sections and the sections are separately transmitted to the search platform. Accordingly, the large language model uses the token to ensure the content coherent and consistent.

In conclusion, according to the above embodiments relating to the input device and the search method performed through the input device, rather than the conventional search method through the search engine, the search method of the present disclosure starts a quick search when the input device triggers a quick search service by submitting a search package including a selected a search target, an identifier (e.g., an API key) obtained from a memory of the input device, and a search description (e.g., a prompt text for a natural language model) to a search engine that can be a natural language model implemented search engine.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A search method performed through an input device, performed in a computer system connected with the input device, comprising:
receiving a search target being selected by using the input device;
generating a search description by the computer system;
retrieving an identifier from a memory of the input device, wherein the identifier corresponds to a search engine;
transmitting the search target, the search description and the identifier to the search engine corresponding to the identifier, and the search engine conducting searching according to the search target and the search description so as to obtain a search result; and
receiving the search result.

2. The search method according to claim 1, wherein, a search hotkey or a combination of multiple keys of the input device is used to trigger execution of the search method performed through the input device.

3. The search method according to claim 1, wherein the search target is a paragraph of text or a picture selected by the input device.

4. The search method according to claim 1, wherein the search description is generated by a search program executed in the computer system for a natural language model.

5. The search method according to claim 4, wherein, a search hotkey or a combination of multiple keys of the input device is used to trigger execution of the search method performed through the input device.

6. The search method according to claim 4, wherein, in the computer system, a token of the natural language model is used to transform a prompt text to information to be processed by the natural language model.

7. The search method according to claim 6, wherein, a search hotkey or a combination of multiple keys of the input device is used to trigger execution of the search method performed through the input device.

8. The search method according to claim 1, wherein the identifier recorded in the memory of the input device is an API key that records a linking data of the search engine.

9. The search method according to claim 8, wherein, a search hotkey or a combination of multiple keys of the input device is used to trigger execution of the search method performed through the input device.

10. The search method according to claim 1, wherein, in the computer system, the search target, the search description and the identifier are packaged in a search package that is transmitted to the search engine corresponding to the identifier via network, and the search engine performs searching according to the search target and the search description in the search package.

11. The search method according to claim 10, wherein, a search hotkey or a combination of multiple keys of the input device is used to trigger execution of the search method performed through the input device.

12. An input device, comprising:
a controller;
a memory, electrically connected with the controller, recording one or more identifiers corresponding to one or more search engines; and
a transmission circuit, electrically connected with the controller, used to connect with a computer system;
wherein, the input device is used to select a search target; the computer system is used to generate a search description and retrieves one of the one or more identifiers from the memory of the input device; the search target, the search description and the identifier are transmitted to one of the one or more search engines corresponding to the identifier; and the search engine conducts searching according to the search target and the search description so as to obtain a search result.

13. The input device according to claim 12, wherein, a search hotkey or a combination of multiple keys of the input device is used to trigger execution of the search method performed through the input device.

14. The input device according to claim 12, wherein the identifier recorded in the memory of the input device is an API key that records a linking data of the search engine.

15. The input device according to claim 14, wherein, a search hotkey or a combination of multiple keys of the input device is used to trigger execution of the search method performed through the input device.
